(19) United States
(12) Patent Application Publication
(10) Pub. No.: US 2025/0042737 A1
(43) Pub. Date: Feb. 6, 2025

(54) PURIFICATION METHOD AND SYSTEM FOR AQUEOUS HYDROGEN PEROXIDE SOLUTION

(71) Applicant: DONGWOO FINE-CHEM CO., LTD., Iksan-si (KR)

(72) Inventors: Hong-Ki MIN, Iksan-si (KR); Dong-Seok SEO, Iksan-si (KR); Uk LEE, Iksan-si (KR)

(73) Assignee: DONGWOO FINE-CHEM CO., LTD., Iksan-si (KR)

(21) Appl. No.: 18/787,111

(22) Filed: Jul. 29, 2024

(30) Foreign Application Priority Data
Jul. 31, 2023 (KR) 10-2023-0099449

(51) Int. Cl. C01B 15/013

(52) U.S. Cl. CPC C01B 15/0135; C01B 2210/001

(57) ABSTRACT

The present disclosure relates to a method and a system for purifying an aqueous hydrogen peroxide solution. According to the present disclosure, it is possible to provide a method and a system for purifying an aqueous hydrogen peroxide solution, which may achieve the purity required in fine chemical fields such as the semiconductor industry field by preventing layer separation of a mixed ion-exchange resin consisting of a cation-exchange resin and an anion-exchange resin and reducing the leaching of ions from the resin during a purification process.

### TECHNICAL FIELD

The present disclosure relates to a method and a system for purifying an aqueous hydrogen peroxide solution by passing the aqueous hydrogen peroxide solution through an ion-exchange resin.

### BACKGROUND ART

Hydrogen peroxide is highly soluble in water, ethanol, and ether, is weakly acidic in aqueous solutions due to partial dissociation of hydrogen ions thereof, and is used as an oxidizing agent in various fields due to its strong oxidizing power. In particular, hydrogen peroxide is used for cleaning semiconductor wafers and for etching in semiconductor and display manufacturing processes, and in this case, high-purity hydrogen peroxide with very low impurity concentration is required.

However, if commercially available hydrogen peroxide is used without purification, it is difficult to produce high-quality products because the concentration of impurities in the hydrogen peroxide is high, which can damage semiconductors. Therefore, high-purity hydrogen peroxide is required in fine chemical fields such as the semiconductor industry field.

Conventional means for purifying hydrogen peroxide include a method of purifying and concentrating hydrogen peroxide by distillation in a column made of aluminum or special steel containing a packing material, but this method has a problem in that various metal ions such as aluminum ions are incorporated into hydrogen peroxide.

As other methods for reducing impurities in aqueous hydrogen peroxide solutions, a method using a reverse osmosis membrane and a method using an ion-exchange resin have been proposed. However, the method using a reverse osmosis membrane has a problem in that the reverse osmosis membrane deteriorates and the maintenance rate thereof decreases as the reverse osmosis membrane is continuously contacted with high-concentration aqueous hydrogen peroxide solutions. Further, the method using an ion-exchange resin has a risk of explosion due to the generation of oxygen gas and the like by the reaction between hydrogen peroxide and the ion-exchange resin, and thus needs to be improved in terms of process stability.

Meanwhile, Japanese Patent Application Publication No. 1996-143303 discloses a method of purifying an aqueous hydrogen peroxide solution using a mixed ion-exchange resin consisting of a cation-exchange resin and an anion-exchange resin to remove dissociable impurities. However, this method has a problem in that the purified aqueous hydrogen peroxide solution does not meet the purity required in fine chemical fields because the concentration of impurities in the purified aqueous hydrogen peroxide solution is still high.

Therefore, there is a need to develop a method and a system for purification of an aqueous hydrogen peroxide solution, which can achieve the purity required in fine chemical fields such as the semiconductor industry field.

### PRIOR ART DOCUMENTS

### Patent Documents

(Patent Document 1) Japanese Patent Application Publication No. 1996-143303

### DISCLOSURE

### Technical Problem

An object of the present disclosure is to provide a method and a system for purifying an aqueous hydrogen peroxide solution, which may achieve the purity required in fine chemical fields such as the semiconductor industry field by preventing layer separation of a mixed ion-exchange resin consisting of a cation-exchange resin and an anion-exchange resin and reducing the leaching of ions from the resin during a purification process.

Another object of the present disclosure is to provide a method and a system for purifying an aqueous hydrogen peroxide solution, which may reduce the risk of explosion by stably discharging the gas generated by the reaction between hydrogen peroxide and an ion-exchange resin, and improve process stability by maintaining the level of the aqueous hydrogen peroxide solution in a purification tower at a constant level.

Still another object of the present disclosure is to provide a method and a system for purifying an aqueous hydrogen peroxide solution, which may improve productivity by increasing purification capacity and purification rate without excessive facility expansion.

Yet another object of the present disclosure is to provide a method and a system for purifying an aqueous hydrogen peroxide solution, which may reduce unwanted gas generation and further improve ion exchange performance by preventing a mixed contact reaction caused by drying of the ion-exchange resin in a purification tower.

However, objects of the present disclosure are not limited to the objects mentioned above, and other objects not mentioned above will be clearly understood by those skilled in the art from the following description.

### Technical Solution

To achieve the above objects, the present disclosure provides a method for purifying an aqueous hydrogen peroxide solution, including steps of: (a) preparing a mixed ion-exchange resin by injecting a gas into a mixture of a cation-exchange resin, an anion-exchange resin, and water, thereby bubbling the mixture; (b) passing the aqueous hydrogen peroxide solution through the mixed ion-exchange resin; and (c) discharging the aqueous hydrogen peroxide solution that passed through the mixed ion-exchange resin.

According to one embodiment of the present disclosure, the ratio of the volume of water (V_{W}) to the total volume (V_{R}) of the cation-exchange resin and the anion-exchange resin, (V_{W}/V_{R}), in step (a), may be 0.1 to 0.3.

According to one embodiment of the present disclosure, step (a) may be performed in a resin mixing tank, and the method may further include, after step (a) and before step (b), step (a-2) of introducing the prepared mixed ion-exchange resin into a purification tower.

According to one embodiment of the present disclosure, the cation-exchange resin and the anion-exchange resin may be included at a volume ratio of 0.8:1.0 to 1.0:0.8.

According to one embodiment of the present disclosure, the water in step (a) may have a resistivity of 18 MΩ·cm or more.

According to one embodiment of the present disclosure, the gas in step (a) may be an unreactive gas or air.

According to one embodiment of the present disclosure, the unreactive gas may be at least one selected from the group consisting of nitrogen, helium, neon, argon, krypton, xenon, and SF₆.

According to one embodiment of the present disclosure, the gas in step (a) may be injected at a pressure of 0.5 to 1.5 kgf/cm².

According to one embodiment of the present disclosure, step (a) may be performed for 24 hours or more.

According to one embodiment of the present disclosure, the method may further include, after step (c), steps of: (d) transferring the aqueous hydrogen peroxide solution discharged in step (c) to an intermediate storage tank; and (e) transferring the aqueous hydrogen peroxide solution in the intermediate storage tank to a subsequent process or a final storage tank through a transfer pipe including a pump.

According to one embodiment of the present disclosure, the level of the aqueous hydrogen peroxide solution in the intermediate storage tank may be 30% or more of the internal height of the intermediate storage tank.

According to one embodiment of the present disclosure, step (e) may be performed using a transfer driving force provided by the pump.

The present disclosure also provides a system for purifying an aqueous hydrogen peroxide solution, including: a purification tower having a gas injection pipe connected thereto; and a discharge pipe connected to the rear end of the purification tower, wherein a mixed ion-exchange resin is prepared by introducing a mixture of a cation-exchange resin, an anion-exchange resin and water into the purification tower, and then injecting a gas into the mixture through the gas injection pipe, thereby bubbling the mixture, and the aqueous hydrogen peroxide solution is introduced into the purification tower and passed through the mixed ion-exchange resin.

The present disclosure also provides a system for purifying an aqueous hydrogen peroxide solution, including: a resin mixing tank having a gas injection pipe and resin transfer pipe connected thereto; a purification tower provided downstream of the resin mixing tank; and a discharge pipe connected to the rear end of the purification tower, wherein a mixed ion-exchange resin is prepared by introducing a mixture of a cation-exchange resin, an anion-exchange resin and water into the resin mixing tank, and then injecting a gas into the mixture through the gas injection pipe, thereby bubbling the mixture, the prepared mixed ion-exchange resin is introduced into the purification tower through the resin transfer pipe, and the aqueous hydrogen peroxide solution is introduced into the purification tower and passed through the mixed ion-exchange resin.

According to one embodiment of the present disclosure, the ratio of the volume of water (V_{W}) to the total volume (V_{R}) of the cation-exchange resin and the anion-exchange resin, (V_{W}/V_{R}), in the mixture, may be 0.1 to 0.3.

According to one embodiment of the present disclosure, the cation-exchange resin and the anion-exchange resin may be included at a volume ratio of 0.8:1.0 to 1.0:0.8.

According to one embodiment of the present disclosure, the water may have a resistivity of 18 MΩ·cm or more.

According to one embodiment of the present disclosure, the gas may be an unreactive gas or air.

According to one embodiment of the present disclosure, the unreactive gas may be at least one selected from the group consisting of nitrogen, helium, neon, argon, krypton, xenon, and SF₆.

According to one embodiment of the present disclosure, the gas may be injected at a pressure of 0.5 to 1.5 kgf/cm².

According to one embodiment of the present disclosure, the gas may be injected for 24 hours or more.

According to one embodiment of the present disclosure, the purification system may further include: an intermediate storage tank connected to the rear end of the discharge pipe; and a transfer pipe connected to the rear end of the intermediate storage tank and including a pump.

According to one embodiment of the present invention, the level of the aqueous hydrogen peroxide solution in the intermediate storage tank may be 30% or more of the internal height of the intermediate storage tank.

### Advantageous Effects

The present disclosure may provide a method and a system for purifying an aqueous hydrogen peroxide solution, which achieve the purity required in fine chemical fields such as the semiconductor industry field by preventing layer separation of a mixed ion-exchange resin consisting of a cation-exchange resin and an anion-exchange resin and reducing the leaching of ions from the resin during a purification process.

The present disclosure may also provide a method and a system for purifying an aqueous hydrogen peroxide solution, which reduce the risk of explosion by stably discharging the gas generated by the reaction between hydrogen peroxide and an ion-exchange resin, and improve process stability by maintaining the level of the aqueous hydrogen peroxide solution in a purification tower at a constant level.

The present disclosure may also provide a method and a system for purifying an aqueous hydrogen peroxide solution, which may improve productivity by increasing purification capacity and purification rate without excessive facility expansion.

The present disclosure may also provide a method and a system for purifying an aqueous hydrogen peroxide solution, which may reduce unwanted gas generation and further improve ion exchange performance by preventing a mixed contact reaction caused by drying of the ion-exchange resin in a purification tower.

### BRIEF DESCRIPTION OF DRAWINGS

FIG. 1 schematically illustrates the configuration of a system for purifying an aqueous hydrogen peroxide solution according to a first embodiment of the present disclosure.

FIG. 2 schematically illustrates the configuration of a system for purifying an aqueous hydrogen peroxide solution according to a second embodiment of the present disclosure.

FIG. 3 schematically illustrates the configuration of a system for purifying an aqueous hydrogen peroxide solution according to a third embodiment of the present disclosure.

FIG. 4 is a reference diagram showing the criteria for evaluating whether the mixed ion-exchange resins used in an example and comparative example of the present disclosure are separated into layers.

### DETAILED DESCRIPTION

The present disclosure relates to a method and a system for purifying an aqueous hydrogen peroxide solution by passing the aqueous hydrogen peroxide solution through an ion-exchange resin, and particularly, to a method and a system for purifying an aqueous hydrogen peroxide solution, which may achieve the purity required in fine chemical fields and improve process stability and productivity.

More specifically, the present disclosure relates to a method for purifying an aqueous hydrogen peroxide solution, including steps of: (a) preparing a mixed ion-exchange resin by injecting a gas into a mixture of a cation-exchange resin, an anion-exchange resin, and water, thereby bubbling the mixture; (b) passing the aqueous hydrogen peroxide solution through the mixed ion-exchange resin; and (c) discharging the aqueous hydrogen peroxide solution that passed through the mixed ion-exchange resin.

The present disclosure also relates to a system for purifying an aqueous hydrogen peroxide solution, including: a purification tower having a gas injection pipe connected thereto; and a discharge pipe connected to the rear end of the purification tower, wherein a mixed ion-exchange resin is prepared by introducing a mixture of a cation-exchange resin, an anion-exchange resin and water into the purification tower, and then injecting a gas into the mixture through the gas injection pipe, thereby bubbling the mixture, and the aqueous hydrogen peroxide solution is introduced into the purification tower and passed through the mixed ion-exchange resin.

The present disclosure also relates to a system for purifying an aqueous hydrogen peroxide solution, including: a resin mixing tank having a gas injection pipe and resin transfer pipe connected thereto; a purification tower provided downstream of the resin mixing tank; and a discharge pipe connected to the rear end of the purification tower, wherein a mixed ion-exchange resin is prepared by introducing a mixture of a cation-exchange resin, an anion-exchange resin and water into the resin mixing tank, and then injecting a gas into the mixture through the gas injection pipe, thereby bubbling the mixture, the prepared mixed ion-exchange resin is introduced into the purification tower through the resin transfer pipe, and the aqueous hydrogen peroxide solution is introduced into the purification tower and passed through the mixed ion-exchange resin.

The method for purifying an aqueous hydrogen peroxide solution according to the present disclosure refers to a method of obtaining an aqueous hydrogen peroxide solution with higher purity by removing impurities from an aqueous hydrogen peroxide solution synthesized in-house or purchased from a supplier.

In addition, the system for purifying an aqueous hydrogen peroxide solution according to the present disclosure refers to the configuration of a purification system and an operation method thereof for obtaining an aqueous hydrogen peroxide solution with higher purity by removing impurities from an aqueous hydrogen peroxide solution synthesized in-house or purchased from a supplier.

Before being purified by the purification method or purification system according to the present disclosure, the aqueous hydrogen peroxide solution may contain undesirable amounts of contaminants and impurities. Through purification by the purification method or purification system according to the present disclosure, significant amounts of contaminants and impurities may be removed from the aqueous hydrogen peroxide solution.

The aqueous hydrogen peroxide solution before being purified by the purification method or purification system according to the present disclosure is also referred to as “unpurified aqueous hydrogen peroxide solution”. The aqueous hydrogen peroxide solution purified by the purification method or purification system according to the present disclosure is also referred to as “purified aqueous hydrogen peroxide solution”.

The “purified aqueous hydrogen peroxide solution” may contain impurities at a limited concentration within a predetermined range. In particular, it is preferable that a purified aqueous hydrogen peroxide solution for use in semiconductor processes has a sodium ion concentration of 10 ppt or less. The aqueous hydrogen peroxide solution purified by the purification method or purification system according to the present disclosure may contain sodium ions at a concentration of 10 ppt or less.

Hereinafter, embodiments of the present disclosure will be described in more detail with reference to the drawings. However, the drawings attached to the present specification illustrate preferred embodiments of the present disclosure, and serve to further understand the technical idea of the present disclosure together with the detailed description of the present disclosure. Accordingly, the present disclosure should not be interpreted as being limited only to the matters shown in these drawings.

In the present specification, singular forms also include plural forms unless the context clearly dictates otherwise. Like reference numerals refer to like components throughout the present specification.

As used herein, the terms “comprises”, “comprising”, “includes”, “including”, “has”, and/or “having” are intended to denote the existence of one or more stated components, steps, operations, and/or devices, and do not exclude the probability of existence or addition of one or more other components, steps, operations, and/or devices.

Spatially relative terms, such as “below”, “lower (end or portion)”, “above”, “upper (end or portion)” and the like, may be used to easily describe the relationship between one component and another component(s) as illustrated in the figures. Spatially relative terms should be understood to encompass different orientations of the component in use or operation in addition to the orientation depicted in the figures

As used herein, the term “connection” is meant to encompass both indirectly connecting a plurality of components and directly connecting a plurality of components.

In the present specification, “ppb” means “parts per billion”, and “ppt” means “parts per trillion”.

### <System for Purifying Aqueous Hydrogen Peroxide Solution>

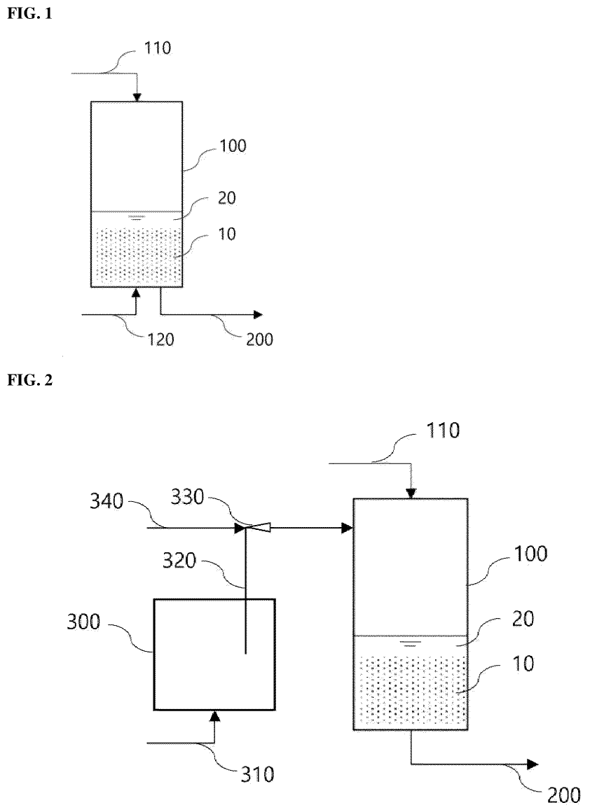

FIGS. 1 to 3 schematically illustrate the configurations of systems for purifying an aqueous hydrogen peroxide solution according to first to third embodiments of the present disclosure.

Referring to FIG. 1, the system for purifying an aqueous hydrogen peroxide solution according to the first embodiment of the present disclosure includes a purification tower 100 having a gas injection pipe 120 connected thereto, and a discharge pipe 200 connected to the rear end of the purification tower 100, wherein an unpurified aqueous hydrogen peroxide solution is introduced into the purification tower 100 through an aqueous hydrogen peroxide solution introduction pipe 110 and purified by passage through a mixed ion-exchange resin 10, and the purified aqueous hydrogen peroxide solution is discharged through the discharge pipe 200.

An unpurified aqueous hydrogen peroxide solution contains various impurities. Generally, a cation-exchange resin is used to remove cationic impurities, and an anion-exchange resin is used to remove anionic impurities. In addition, a mixed ion-exchange resin consisting of a cation-exchange resin and an anion-exchange resin may be used to simultaneously remove cationic and anionic impurities, thereby increasing process efficiency. However, since the cation-exchange resin and the anion-exchange resin have different specific gravities, it is difficult for a conventional stirring method to prevent layer separation from occurring after mixing. If layer separation of the mixed ion-exchange resin occurs, a problem arises in that leaching of ions from the resin occurs, thereby reducing the dissociable impurity removal performance of the resin.

The system for purifying an aqueous hydrogen peroxide solution according to the present disclosure is characterized by preparing a mixed ion-exchange resin through bubbling to prevent layer separation of the mixed ion-exchange resin. More specifically, after a mixture of a cation-exchange resin, an anion-exchange resin, and water is introduced into the purification tower 100, a gas is injected into the mixture through the gas injection pipe 120, bubbling the mixture, thereby preparing the mixed ion-exchange resin 10.

As the mixed ion-exchange resin 10 is prepared by sufficiently mixing the cation-exchange resin and the anion-exchange resin through bubbling as described above, the system for purifying an aqueous hydrogen peroxide solution according to the present disclosure may prevent layer separation of the mixed ion-exchange resin during a purification process, thereby reducing the leaching of ions from the resin. Accordingly, it is possible to obtain a high-purity aqueous hydrogen peroxide solution that meets the purity required in fine chemical fields.

The mixed ion-exchange resin 10 is prepared using a mixture of a cation-exchange resin, an anion-exchange resin, and water, and in this case, the ratio of the volume of water (V_{W}) to the total volume (V_{R}) of the cation-exchange resin and the anion-exchange resin needs to be appropriately controlled within a predetermined range. More specifically, in the mixture of the cation-exchange resin, the anion-exchange resin, and water, the ratio of the volume of water (V_{W}) to the total volume (V_{R}) of the cation-exchange resin and the anion-exchange resin, (V_{W}/V_{R}), may be 0.1 to 0.3, preferably 0.1 to 0.2. If the ratio of the volume of water (V_{W}) to the total volume (V_{R}) of the cation-exchange resin and the anion-exchange resin, (V_{W}/V_{R}), in the mixture, is less than 0.1, a problem may arise in that the entire amount of the cation-exchange resin and the anion-exchange resin is not completely mixed, and if the ratio of the volume is more than 0.3, a problem may arise in that layer separation of the mixed ion-exchange resin occurs again during the purification process.

The cation-exchange resin is not particularly limited as long as it can remove cationic impurities from the aqueous hydrogen peroxide solution. Specifically, the cation-exchange resin may be at least one selected from the group consisting of strongly acidic cation-exchange resins having a polystyrene matrix and a sulfonic acid group.

The anion-exchange resin is not particularly limited as long as it can remove anionic impurities from the aqueous hydrogen peroxide solution. Specifically, the anion-exchange resin may be at least one selected from the group consisting of strongly basic anion-exchange resins having a quaternary ammonium group in the styrene framework.

The cation-exchange resin and the anion-exchange resin may be included at a volume ratio of 0.8:1.0 to 1.0:0.8, and when the above volume ratio is satisfied, there is an advantage in that effective mutual purification of impurities generated from each ion-exchange resin is possible, which is preferable.

As the water that is used in the preparation of the mixed ion-exchange resin, pure water may be used. It is preferable to use water having a resistivity of 18 MΩ·cm or more in order to prevent a decrease in the ion-exchange capacity of the ion-exchange resin.

The gas that is injected during the preparation of the mixed ion-exchange resin may be an unreactive gas or air. The unreactive gas may be at least one selected from the group consisting of nitrogen, helium, neon, argon, krypton, xenon, and SF₆, and is preferably nitrogen. In addition, the gas may be used after passing through a filter to prevent the incorporation of impurities, and the filter may be a filter with a filtration rating of 0.001 to 0.01 μm.

The gas that is injected during the preparation of the mixed ion-exchange resin may be injected at a pressure of 0.5 to 1.5 kgf/cm², preferably 0.8 to 1.2 kgf/cm². When the gas is injected at a pressure within the above pressure range, there is an advantage in that physical stability during mixing may be ensured and stable mixing may be guaranteed, thereby preventing layer separation of the mixed ion-exchange resin, which is preferable.

The gas that is injected during the preparation of the mixed ion-exchange resin may be injected for 24 hours or more, preferably 36 hours or more, more preferably 48 hours or more. When gas is injected for a time period within the above time range, the ion-exchange resins may be completely mixed, thereby preventing layer separation more effectively, which is preferable. Although the upper limit of the gas injection time is not particularly limited, it may be 150 hours or less, preferably 120 hours or less, from the viewpoint of mixing efficiency according to the process time.

FIG. 2 schematically illustrates the configuration of a system for purifying an aqueous hydrogen peroxide solution according to a second embodiment of the present disclosure. The system for purifying an aqueous hydrogen peroxide solution illustrated in FIG. 2 further includes a resin mixing tank 300 in addition to the system for purifying an aqueous hydrogen peroxide solution according to the first embodiment illustrated in FIG. 1. The above description of the system for purifying an aqueous hydrogen peroxide solution according to FIG. 1 may be equally applied to the system for purifying an aqueous hydrogen peroxide solution illustrated in FIG. 2, and detailed description of substantially identical or similar structures and configurations will be omitted.

The system for purifying an aqueous hydrogen peroxide solution according to the second embodiment of the present disclosure may include: a resin mixing tank 300 having a gas injection pipe 310 and resin transfer pipe 320 connected thereto; a purification tower 100 provided downstream of the resin mixing tank 300; and a discharge pipe 200 connected to the rear end of the purification tower 100.

The system for purifying an aqueous hydrogen peroxide solution according to the second embodiment of the present disclosure is characterized in that a mixed ion-exchange resin 10 is prepared in the resin mixing tank 300 and then introduced into the purification tower 100 through the resin transfer pipe 320. Since the mixed ion-exchange resin that is used for the purification of the aqueous hydrogen peroxide solution has a certain ion-exchange capacity, it needs to be replaced after being used in the purification process for a certain period of time. In this case, when the mixed ion-exchange resin is prepared in a separate resin mixing tank 300 and then introduced into the purification tower 100, there is an advantage in that the operation of the purification tower 100 may be maintained during preparation of the mixed ion-exchange resin, and thus the overall process efficiency is improved.

In the system for purifying an aqueous hydrogen peroxide solution according to the second embodiment of the present disclosure, the mixed ion-exchange resin 10 may be prepared by introducing a mixture of a cation-exchange resin, an anion-exchange resin, and water into the resin mixing tank 300, and then injecting a gas into the mixture through the gas injection pipe 310, thereby bubbling the mixture.

The mixed ion-exchange resin 10 prepared as described above is introduced into the purification tower 100 through the resin transfer pipe 320. For example, the mixed ion-exchange resin 10 may be introduced into the purification tower 100 through the resin transfer pipe 320 including an ejector 330, without being limited thereto. More specifically, the ejector 330 is provided in the resin transfer pipe 320, and the ejector 330 is provided such that one end with a smaller diameter (hereinafter also referred to as the “front end”) faces the resin mixing tank 300 and the other end with a larger diameter (hereinafter also referred to as the “rear end”) faces the purification tower 100. In addition, a fluid injection part 340 is connected to the front end of the ejector 330. When a fluid is injected through the fluid injection part 340, it flows through a narrow passage with a small diameter in the front end of the ejector 330, and thus the flow velocity increases and the pressure decreases in the front end of the ejector 330. Accordingly, a pressure difference is generated between the front end of the ejector 330 and the interior of the resin mixing tank 300, so that the mixed ion-exchange resin 10 in the resin mixing tank 300 is pulled up toward the resin transfer pipe 320 where the ejector 330 is located, and using this as a driving force, the mixed ion-exchange resin 10 is introduced into the purification tower 100.

As the fluid that is injected through the fluid injection part 340, pure water may be used, and it is preferable to use water having a resistivity of 18 MΩ·cm or more in order to prevent a decrease in the ion-exchange capacity of the ion-exchange resin.

After the mixed ion-exchange resin 10 prepared in the resin mixing tank 300 is introduced into the purification tower 100, an unpurified aqueous hydrogen peroxide solution is introduced into the purification tower 100 through an aqueous hydrogen peroxide solution introduction pipe 110. The introduced unrefined aqueous hydrogen peroxide solution is purified by passage through the mixed ion-exchange resin 10, and the purified aqueous hydrogen peroxide solution is discharged through the discharge pipe 200.

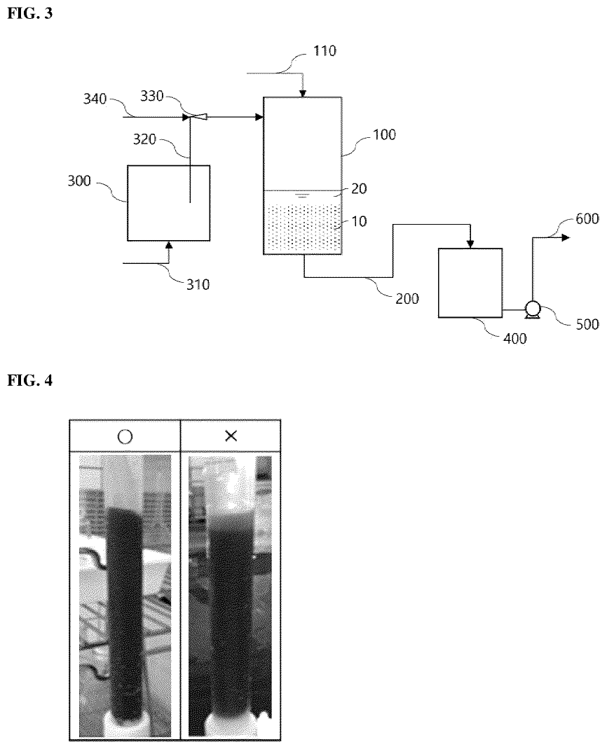

FIG. 3 schematically illustrates the configuration of a system for purifying an aqueous hydrogen peroxide solution according to a third embodiment of the present disclosure. The system for purifying an aqueous hydrogen peroxide solution illustrated in FIG. 3 further includes an intermediate storage tank 400, a pump 500, and a transfer pipe 600, in addition to the system for purifying an aqueous hydrogen peroxide solution according to the second embodiment illustrated in FIG. 2. The above description of the systems for purifying an aqueous hydrogen peroxide solution according to FIG. 1 may be equally applied to the system for purifying an aqueous hydrogen peroxide solution illustrated in FIG. 3, and detailed description of substantially identical or similar structures and configurations will be omitted.

The system for purifying an aqueous hydrogen peroxide solution according to the third embodiment of the present disclosure may include: a resin mixing tank 300 having a gas injection pipe 310 and resin transfer pipe 320 connected thereto; a purification tower 100 provided downstream of the resin mixing tank 300; a discharge pipe 200 connected to the rear end of the purification tower 100; an intermediate storage tank 400 connected to the rear end of the discharge pipe 200; and a transfer pipe 600 connected to the rear end of the intermediate storage tank 400.

The purification tower 100 includes the mixed ion-exchange resin 10 therein, and an unpurified aqueous hydrogen peroxide solution is introduced into the purification tower through an aqueous hydrogen peroxide solution introduction pipe 110. The introduced unrefined aqueous hydrogen peroxide solution is purified while passing from top to bottom through the mixed ion-exchange resin 10, and the purified aqueous hydrogen peroxide solution is discharged through the discharge pipe 200 connected to the bottom of the purification tower 100. The discharged purified aqueous hydrogen peroxide solution is stored temporarily in the intermediate storage tank 400 and transferred to a subsequent process or a final storage tank through the transfer pipe 600 connected to the rear end of the intermediate storage tank 400.

The mixed ion-exchange resin 10 may be packed to a height of 30 to 90%, preferably 30 to 80%, more preferably 30 to 70%, of the internal height of the purification tower 100, taking into consideration the control of gas generated within the purification tower 100 and the efficiency of purification of the aqueous hydrogen peroxide solution.

Here, it is preferable to maintain the level of the aqueous hydrogen peroxide solution 20 in the purification tower 100 at a level equal to or higher than the height of the mixed ion-exchange resin 10 in order to prevent a part of the mixed ion-exchange resin 10 in the purification tower 100 from being dried by exposure without being submerged in the aqueous hydrogen peroxide solution 20.

The level of the aqueous hydrogen peroxide solution in the intermediate storage tank 400 is preferably 30% or more of the internal height of the intermediate storage tank 400. When this is satisfied, there is an advantage in that it is possible to prevent a pump 500 described later from idling due to a drop in the level of the aqueous hydrogen peroxide solution.

The system for purifying an aqueous hydrogen peroxide solution according to the present disclosure may further include a pump 500 connected to the rear end of the intermediate storage tank 400 and configured to provide a driving force to the transfer pipe 600.

If the pump 500 is provided upstream of the intermediate storage tank 400, i.e., downstream of the purification tower 100, there is a limit to increasing the transport driving force due to problems such as leakage of the mixed ion-exchange resin 10 from the purification tower 100, and thus it is difficult to provide a sufficient transport driving force. Accordingly, in the system for purifying an aqueous hydrogen peroxide solution according to the present disclosure, the pump 500 is provided downstream of the intermediate storage tank 400, and thus there is an advantage in that the pump may provide a sufficient transfer driving force to the transfer pipe 600 while solving the problem of leakage of the mixed ion-exchange resin 10.

The system for purifying an aqueous hydrogen peroxide solution according to the present disclosure may include the entire configuration of the above-described purification system as a single unit or multiple units, and when the system includes the entire configuration as multiple units, the purity of the purified aqueous hydrogen peroxide solution may be further increased by repeatedly performing the process of purifying the aqueous hydrogen peroxide solution.

### <Method for Purifying Aqueous Hydrogen Peroxide Solution>

The method for purifying an aqueous hydrogen peroxide solution according to the present disclosure may include steps of: (a) preparing a mixed ion-exchange resin by injecting a gas into a mixture of a cation-exchange resin, an anion-exchange resin, and water, thereby bubbling the mixture; (b) passing the aqueous hydrogen peroxide solution through the mixed ion-exchange resin; and (c) discharging the aqueous hydrogen peroxide solution that passed through the mixed ion-exchange resin. In addition, the method may further include, after step (a) and before step (b), step (a-2) of introducing the prepared mixed ion-exchange resin into a purification tower, and may further include, after step (c), steps of: (d) transferring the aqueous hydrogen peroxide solution discharged in step (c) to an intermediate storage tank; (e) transferring the aqueous hydrogen peroxide solution in the intermediate storage tank to a subsequent process or a final storage tank through a transfer pipe including a pump.

The method for purifying an aqueous hydrogen peroxide solution according to the present disclosure may be a method of purifying an aqueous hydrogen peroxide solution using the above-described system for purifying an aqueous hydrogen peroxide solution, and the contents described above in the section “System for Purifying Aqueous Hydrogen Peroxide Solution” may be applied to the method without limitation.

### (a) Step of Preparing Mixed Ion-Exchange Resin

The method for purifying an aqueous hydrogen peroxide solution according to the present disclosure includes a step of preparing a mixed ion-exchange resin by injecting gas into a mixture of a cation-exchange resin, an anion-exchange resin, and water, thereby bubbling the mixture.

As described above, a mixed ion-exchange resin consisting of a cation-exchange resin and an anion-exchange resin may be used to remove various impurities contained in an unpurified aqueous hydrogen peroxide solution, but there is a problem in that it is difficult for a conventional stirring method to prevent layer separation from occurring after mixing.

Accordingly, the method for purifying an aqueous hydrogen peroxide solution according to the present disclosure is characterized by preparing a mixed ion-exchange resin through bubbling to prevent layer separation of the mixed ion-exchange resin. As the mixed ion-exchange resin is prepared by sufficiently mixing the cation-exchange resin and the anion-exchange resin through bubbling as described above, it is possible to prevent layer separation of the mixed ion-exchange resin during a purification process, thereby reducing the leaching of ions from the resin. Accordingly, it is possible to obtain a high-purity aqueous hydrogen peroxide solution that meets the purity required in fine chemical fields.

For the preparation of the mixed ion-exchange resin, the ratio of the volume of water (V_{W}) to the total volume (V_{R}) of the cation-exchange resin and the anion-exchange resin needs to be appropriately controlled within a predetermined range. More specifically, in the mixture of the cation-exchange resin, the anion-exchange resin, and water, the ratio of the volume of water (V_{W}) to the total volume (V_{R}) of the cation-exchange resin and the anion-exchange resin, (V_{W}/V_{R}), may be 0.1 to 0.3, preferably 0.1 to 0.2. If the ratio of the volume of water (V_{W}) to the total volume (V_{R}) of the resins, (V_{W}/V_{R}), in the mixture, is less than 0.1, a problem may arise in that the entire amount of the cation-exchange resin and the anion-exchange resin is not completely mixed, and if the ratio of the volume is more than 0.3, a problem may arise in that layer separation of the mixed ion-exchange resin occurs again during the purification process.

The cation-exchange resin is not particularly limited as long as it can remove cationic impurities from the aqueous hydrogen peroxide solution. Specifically, the cation-exchange resin may be at least one selected from the group consisting of strongly acidic cation-exchange resins having a polystyrene matrix and a sulfonic acid group.

The anion-exchange resin is not particularly limited as long as it can remove anionic impurities from the aqueous hydrogen peroxide solution. Specifically, the anion-exchange resin may be at least one selected from the group consisting of strongly basic anion-exchange resins having a quaternary ammonium group in the styrene framework.

The cation-exchange resin and the anion-exchange resin may be included at a volume ratio of 0.8:1.0 to 1.0:0.8, and when the above volume ratio is satisfied, there is an advantage in that effective mutual purification of impurities generated from each ion-exchange resin is possible, which is preferable.

As the water that is used in the preparation of the mixed ion-exchange resin, pure water may be used. It is preferable to use water having a resistivity of 18 MΩ·cm or more in order to prevent a decrease in the ion-exchange capacity of the ion-exchange resin.

The gas that is injected during the preparation of the mixed ion-exchange resin may be an unreactive gas or air. The unreactive gas may be at least one selected from the group consisting of nitrogen, helium, neon, argon, krypton, xenon, and SF₆, and is preferably nitrogen. In addition, the gas may be used after passing through a filter to prevent the incorporation of impurities, and the filter may be a filter with a filtration rating of 0.001 to 0.1 μm.

The gas that is injected during the preparation of the mixed ion-exchange resin may be injected at a pressure of 0.5 to 1.5 kgf/cm², preferably 0.8 to 1.2 kgf/cm². When the gas is injected at a pressure within the above pressure range, there is an advantage in that physical stability during mixing may be ensured and stable mixing may be guaranteed, thereby preventing layer separation of the mixed ion-exchange resin, which is preferable.

The gas that is injected during the preparation of the mixed ion-exchange resin may be injected for 24 hours or more, preferably 36 hours or more, more preferably 48 hours or more. When gas is injected for a time period within the above time range, the ion-exchange resins may be completely mixed, thereby preventing layer separation more effectively, which is preferable. Although the upper limit of the gas injection time is not particularly limited, it may be 150 hours or less, preferably 120 hours or less, from the viewpoint of mixing efficiency according to the process time.

The preparation of the mixed ion-exchange resin may be performed in the purification tower 100. In this case, the mixed ion-exchange resin may be used directly for purification of an unpurified aqueous hydrogen peroxide solution.

Alternatively, the preparation of the mixed ion-exchange resin may be performed in a separate resin mixing tank 300. In this case, the method may further include a step of injecting the prepared mixed ion-exchange resin into the purification tower 100, and then the prepared mixed ion-exchange resin may be used for purification of the unpurified aqueous hydrogen peroxide solution. Since the mixed ion-exchange resin that is used for the purification of the aqueous hydrogen peroxide solution has a certain ion-exchange capacity, it needs to be replaced after being used in the purification process for a certain period of time. In this case, when the mixed ion-exchange resin is prepared in a separate resin mixing tank 300 and then introduced into the purification tower 100, there is an advantage in that the operation of the purification tower 100 may be maintained during the preparation of the mixed ion-exchange resin, and thus the overall process efficiency is improved.

The mixed ion-exchange resin 10 may be packed to a height of 30 to 90%, preferably 30 to 80%, more preferably 30 to 70%, of the internal height of the purification tower 100, taking into consideration the control of gas generated within the purification tower 100 and the efficiency of purification of the aqueous hydrogen peroxide solution.

(b) Step of Passing Aqueous Hydrogen Peroxide Solution through Mixed Ion-Exchange Resin

The method for purifying an aqueous hydrogen peroxide solution according to the present disclosure includes a step of supplying the unpurified aqueous hydrogen peroxide solution to the purification tower 100 including the mixed ion-exchange resin 10 and passing the unpurified aqueous hydrogen peroxide solution through the mixed ion-exchange resin.

The unpurified aqueous hydrogen peroxide solution may be purified while passing from top to bottom through the mixed ion-exchange resin 10 or passing from bottom to top through the mixed ion-exchange resin 10. Preferably, the unpurified aqueous hydrogen peroxide solution may be purified while passing from top to bottom through the mixed ion-exchange resin 10. As the aqueous hydrogen peroxide solution passes from top to bottom through the mixed ion-exchange resin 10 in the purification tower 100, it is possible to prevent the ion exchange efficiency of the mixed ion-exchange resin 10 from being lowered due to floating of the mixed ion-exchange resin 10, and it is possible to sufficiently improve the purification capacity and purification rate for the aqueous hydrogen peroxide solution without excessively increasing the purification tower.

The amount of aqueous hydrogen peroxide solution supplied from the top of the mixed ion-exchange resin 10 and the amount of aqueous hydrogen peroxide solution discharged from the bottom of the mixed ion-exchange resin 10 are controlled so that the mixed ion-exchange resin 10 may be completely submerged in the aqueous hydrogen peroxide solution 20. These amounts may be controlled so that the level of the aqueous hydrogen peroxide solution 20 is stably maintained through steps (c) to (e) described below.

Here, it is preferable to maintain the level of the aqueous hydrogen peroxide solution 20 in the purification tower 100 at a level equal to or higher than the height of the mixed ion-exchange resin 10 in order to prevent a part of the mixed ion-exchange resin 10 in the purification tower 100 from being dried by exposure without being submerged in the aqueous hydrogen peroxide solution 20.

By preventing a part of the mixed ion-exchange resin 10 from being dried by exposure without being submerged in the aqueous hydrogen peroxide solution 20 as described above, it is possible to minimize the generation of gas in the process of purifying the aqueous hydrogen peroxide solution, and it is possible to minimize the generation of impurities due to gas while preventing the risk of explosion due to gas generation during the process without expanding facilities, thereby increasing the purification efficiency.

In the method for purifying an aqueous hydrogen peroxide solution according to the present disclosure, step (b) may be repeatedly performed, and in this case, the mixed ion-exchange resins 10 included in a plurality of purification towers 100 may be of the same type or different types.

### (c) Step of Discharging Aqueous Hydrogen Peroxide Solution

The method for purifying an aqueous hydrogen peroxide solution according to the present disclosure includes a step of discharging the aqueous hydrogen peroxide solution that passed through the mixed ion-exchange resin.

The purified aqueous hydrogen peroxide solution that passed through the mixed ion-exchange resin 10 in the purification tower 100 may be discharged through the discharge pipe 200, and the discharged purified aqueous hydrogen peroxide solution is transferred to a subsequent process or a final storage tank.

### (d) Step of Transferring Discharged Aqueous Hydrogen Peroxide Solution to Intermediate Storage Tank

The method for purifying an aqueous hydrogen peroxide solution according to the present disclosure may further include a step of transferring the aqueous hydrogen peroxide solution discharged in step (c) to the intermediate storage tank 400.

The level of the aqueous hydrogen peroxide solution in the intermediate storage tank 400 may be 30% or more of the internal height of the intermediate storage tank 400. When this is satisfied, there is an advantage in that it is possible to prevent the pump 500 from idling due to a drop in the level of the aqueous hydrogen peroxide solution.

(e) Step of Transferring Aqueous Hydrogen Peroxide Solution through Transfer Pipe

The method for purifying an aqueous hydrogen peroxide solution according to the present disclosure may further include a step of transferring the aqueous hydrogen peroxide solution in the intermediate storage tank 400 to a subsequent process or a final storage tank through the transfer pipe 600 including the pump 500, wherein the transfer step may be performed using a transfer driving force provided by the pump 500.

In step (d) above, in order to maintain the level of the aqueous hydrogen peroxide solution in the intermediate storage tank 400, the transfer driving force provided by the pump 500 is preferably controlled to a constant level, and accordingly, the flow rate of the aqueous hydrogen peroxide solution that is transferred through the transfer pipe 600 may be maintained at a constant level.

By maintaining the level of the aqueous hydrogen peroxide solution in the intermediate storage tank 400 at a constant level as described above, the level of the aqueous hydrogen peroxide solution in the purification tower 100 may also be maintained at a constant level.

In the method for purifying an aqueous hydrogen peroxide solution according to the present disclosure, the above-described overall process for purifying an aqueous hydrogen peroxide solution may be repeatedly performed, thereby further increasing the purity of the purified aqueous hydrogen peroxide solution.

Hereinafter, examples of the present disclosure will be described in detail. However, the present disclosure is not limited to the embodiments disclosed below, but may be embodied in various different forms. Rather, these examples are provided so that this disclosure will be thorough and complete, and will fully convey the scope of the present disclosure to those skilled in the art. The scope of the present disclosure will be defined by the appended claims.

### EXAMPLES AND COMPARATIVE EXAMPLES

### Example 1

A mixture of 275 L of a cation-exchange resin (functional group: sulfonic acid group; ion exchange capacity: 2.0 eq/L; effective acidity: pH 0 to 14), 275 L of an anion-exchange resin (functional group: quaternary ammonium group; ion exchange capacity: 1.0 eq/L; effective acidity: pH 1 to 14), and 55 L of water (resistivity: 18.2 MΩ·cm) was introduced into a purification tower with an inner diameter of 700 mm and an internal height of 3600 mm. Then, air that passed through a filter (filtration rating: 0.05 μm) was injected into the mixture through a gas injection valve, connected to the bottom of the purification tower, at a pressure of 1.0 kgf/cm² for 24 hours, bubbling the mixture, thereby preparing a mixed ion-exchange resin. The height of the prepared mixed ion-exchange resin was 40% (1440 mm) of the internal height of the purification tower. Thereafter, an unpurified aqueous hydrogen peroxide solution (31%; impurity level: 10 ppb) was introduced into the purification tower through the introduction pipe connected to the top of the purification tower and passed through the mixed ion-exchange resin, and at this time, the temperature was maintained below 15° C.

The purified aqueous hydrogen peroxide solution (31%) that passed through the mixed ion-exchange resin was discharged at a flow rate of 1,650 L/hr through a discharge pipe connected to the bottom of the purification tower.

### Example 2

An unpurified aqueous hydrogen peroxide solution was purified in the same manner as in Example 1, except that a mixture of 275 L of the cation-exchange resin, 275 L of the anion-exchange resin and 110 L of water was used to prepare a mixed ion-exchange resin.

### Example 3

An unpurified aqueous hydrogen peroxide solution was purified in the same manner as in Example 1, except that a mixture of 275 L of the cation-exchange resin, 275 L of the anion-exchange resin and 165 L of water was used to prepare a mixed ion-exchange resin.

### Example 4

An unpurified aqueous hydrogen peroxide solution was purified in the same manner as in Example 1, except that a mixture of 275 L of the cation-exchange resin, 275 L of the anion-exchange resin and 198 L of water was used to prepare a mixed ion-exchange resin.

### Example 5

An unpurified aqueous hydrogen peroxide solution was purified in the same manner as in Example 1, except that a mixture of 220 L of the cation-exchange resin, 275 L of the anion-exchange resin and 79 L of water was used to prepare a mixed ion-exchange resin.

### Example 6

An unpurified aqueous hydrogen peroxide solution was purified in the same manner as in Example 1, except that a mixture of 275 L of the cation-exchange resin, 220 L of the anion-exchange resin and 79 L of water was used to prepare a mixed ion-exchange resin.

### Example 7

An unpurified aqueous hydrogen peroxide solution was purified in the same manner as in Example 1, except that a mixture of 165 L of the cation-exchange resin, 275 L of the anion-exchange resin and 70 L of water was used to prepare a mixed ion-exchange resin.

### Example 8

An unpurified aqueous hydrogen peroxide solution was purified in the same manner as in Example 1, except that a mixture of 275 L of the cation-exchange resin, 165 L of the anion-exchange resin and 70 L of water was used to prepare a mixed ion-exchange resin.

### Example 9

An unpurified aqueous hydrogen peroxide solution was purified in the same manner as in Example 2, except that air was injected for 10 hours during the preparation of the mixed ion-exchange resin.

### Example 10

An unpurified aqueous hydrogen peroxide solution was purified in the same manner as in Example 2, except that air was injected for 48 hours during the preparation of the mixed ion-exchange resin.

### Example 11

An unpurified aqueous hydrogen peroxide solution was purified in the same manner as in Example 2, except that the mixed ion-exchange resin was prepared in a separate resin mixing tank and then introduced into the purification tower.

### Example 12

An unpurified aqueous hydrogen peroxide solution was purified in the same manner as in Example 2, except that the aqueous hydrogen peroxide solution discharged through the discharge pipe was transferred to an intermediate storage tank (inner diameter: 1,000 mm; internal height: 1,500 mm), and the aqueous hydrogen peroxide solution temporarily stored in the intermediate storage tank was transferred to a final storage tank through a transfer pipe including a pump. In this case, the level of the aqueous hydrogen peroxide solution transferred to the intermediate storage tank was controlled to be maintained at 50% of the internal height of the intermediate storage tank.

### Comparative Example 1

An unpurified aqueous hydrogen peroxide solution was purified in the same manner as in Example 1, except that a mixed ion-exchange resin was prepared by stirring and mixing without air injection.

### Experimental Example

### 1. Evaluation of Whether Layer Separation of Mixed Ion-Exchange Resin Occurs

Each of the mixed ion-exchange resins prepared in the Examples and the Comparative Example was placed in a 50 L cylinder, and whether layer separation of each resin occurred was visually observed after 1 hour and 14 days. Evaluation was performed according to the following criteria, and the results are shown in Table 1 below:

### <Criteria for Evaluation of Layer Separation>

o: no layer separation occurred (see “o” in FIG. 4)
x: layer separation occurred (see “x” in FIG. 4)

### 2. Evaluation of Purity of Purified Aqueous Hydrogen Peroxide Solution

For the aqueous hydrogen peroxide solutions purified through the Examples and the Comparative Example, the concentration of sodium ions was measured on a daily basis for two months using an inductively coupled plasma-mass spectrometer (ICP-MS; Agilent, 8900). Evaluation was performed according to the following criteria, and the results are shown in Table 1 below:

### <Criteria for Evaluation of Purity of Purified Hydrogen Peroxide Solution>

⊚: Average sodium ion concentration=0.005 ppb or less
o: Average sodium ion concentration=more than 0.005 ppb to 0.01 ppb or less
Δ: Average sodium ion concentration=more than 0.01 ppb to 0.02 ppb or less
x: Average sodium ion concentration=more than 0.02 ppb

### 3. Evaluation of Amount of Gas Generated in Purification Tower

The amount of gas generated in the purification tower was measured for 1 week using a gas flow meter installed on the top of the purification tower. Evaluation was performed according to the following criteria, and the results are shown in Table 1 below:

### <Criteria for Evaluation of Amount of Gas Generated in Purification Tower>

o: amount of gas generated=less than 7 L/hr
Δ: amount of gas generated=7 L/hr to less than 10 L/hr
x: amount of gas generated=10 L/hr or more

TABLE 1

| | Evaluation of | Evaluation of | | |
|---|---|---|---|---|
| | whether layer | whether layer | Evaluation | Evaluation |
| | separation of | separation of | of purity | of amount |
| | mixed ion- | mixed ion- | of aqueous | of gas |
| | exchange resin | exchange resin | hydrogen | generated in |
| | occurred | occurred | peroxide | purification |
| | (after 1 hour) | (after 14 days) | solution | tower |
| Example 1 | ◯ | ◯ | ⊚ | Δ |
| Example 2 | ◯ | ◯ | ⊚ | Δ |
| Example 3 | ◯ | ◯ | ⊚ | Δ |
| Example 4 | ◯ | X | ⊚ | Δ |
| Example 5 | ◯ | ◯ | ⊚ | Δ |
| Example 6 | ◯ | ◯ | ⊚ | Δ |
| Example 7 | ◯ | ◯ | ◯ | Δ |
| Example 8 | ◯ | ◯ | ◯ | Δ |
| Example 9 | ◯ | X | ⊚ | Δ |
| Example 10 | ◯ | ◯ | ⊚ | Δ |
| Example 11 | ◯ | ◯ | ⊚ | Δ |
| Example 12 | ◯ | ◯ | ⊚ | ◯ |
| Comparative | X | X | X | X |
| Example 1 | | | | |

Reference Numeral

| | |
|---|---|
| 10: Mixed ion-exchange resin | 20: Aqueous hydrogen peroxide |
| | solution |
| 100: Purification tower | |
| 110: Aqueous hydrogen peroxide | |
| solution introduction pipe | |
| 120: Gas injection pipe | 200: Discharge pipe |
| 300: Resin mixing tank | 310: Gas injection pipe |
| 320: Resin transfer pipe | 330: Ejector |
| 340: Fluid injection part | 400: Intermediate storage tank |
| 500: Pump | 600: Transfer pipe |

What is claimed is:

1. A method for purifying an aqueous hydrogen peroxide solution, comprising steps of:
(a) preparing a mixed ion-exchange resin by injecting a gas into a mixture of a cation-exchange resin, an anion-exchange resin, and water, thereby bubbling the mixture;
(b) passing the aqueous hydrogen peroxide solution through the mixed ion-exchange resin; and
(c) discharging the aqueous hydrogen peroxide solution that passed through the mixed ion-exchange resin.

2. The method of claim 1, wherein a ratio of a volume of the water (V_{W}) to a total volume (V_{R}) of the cation-exchange resin and the anion-exchange resin, (V_{W}/V_{R}), in step (a), is 0.1 to 0.3.

3. The method of claim 1, wherein step (a) is performed in a resin mixing tank, and the method further comprises, after step (a) and before step (b), step (a-2) of introducing the prepared mixed ion-exchange resin into a purification tower.

4. The method of claim 1, wherein the cation-exchange resin and the anion-exchange resin in step (a) are included at a volume ratio of 0.8:1.0 to 1.0:0.8.

5. The method of claim 1, wherein the water in step (a) has a resistivity of 18 MΩ·cm or more.

6. The method of claim 1, wherein the gas in step (a) is an unreactive gas or air.

7. The method of claim 6, wherein the unreactive gas is at least one selected from the group consisting of nitrogen, helium, neon, argon, krypton, xenon, and SF₆.

8. The method of claim 1, wherein the gas in step (a) is injected at a pressure of 0.5 to 1.5 kgf/cm².

9. The method of claim 1, wherein step (a) is performed for 24 hours or more.

10. The method of claim 1, further comprising, after step (c), steps of:
(d) transferring the aqueous hydrogen peroxide solution discharged in step (c) to an intermediate storage tank; and
(e) transferring the aqueous hydrogen peroxide solution in the intermediate storage tank to a subsequent process or a final storage tank through a transfer pipe including a pump.

11. The method of claim 10, wherein a level of the aqueous hydrogen peroxide solution in the intermediate storage tank is 30% or more of an internal height of the intermediate storage tank.

12. The method of claim 10, wherein step (e) is performed using a transfer driving force provided by the pump.

13. A system for purifying an aqueous hydrogen peroxide solution, comprising:
a purification tower having a gas injection pipe connected thereto; and
a discharge pipe connected to a rear end of the purification tower,
wherein a mixed ion-exchange resin is prepared by introducing a mixture of a cation-exchange resin, an anion-exchange resin and water into the purification tower, and then injecting a gas into the mixture through the gas injection pipe, thereby bubbling the mixture, and
the aqueous hydrogen peroxide solution is introduced into the purification tower and passed through the mixed ion-exchange resin.

14. The system of claim 13, wherein a ratio of a volume of the water (V_{W}) to a total volume (V_{R}) of the cation-exchange resin and the anion-exchange resin, (V_{W}/V_{R}), in the mixture, is 0.1 to 0.3.

15. The system of claim 13, wherein the cation-exchange resin and the anion-exchange resin are included at a volume ratio of 0.8:1.0 to 1.0:0.8.

16. The system of claim 13, wherein the water has a resistivity of 18 MΩ·cm or more.

17. The system of claim 13, wherein the gas is an unreactive gas or air.

18. The system of claim 17, wherein the unreactive gas is at least one selected from the group consisting of nitrogen, helium, neon, argon, krypton, xenon, and SF₆.

19. The system of claim 13, wherein the gas is injected at a pressure of 0.5 to 1.5 kgf/cm².

20. The system of claim 13, wherein the gas is injected for 24 hours or more.

21. The system of claim 13, further comprising:
an intermediate storage tank connected to a rear end of the discharge pipe; and
a transfer pipe connected to a rear end of the intermediate storage tank and including a pump.

22. The system of claim 21, wherein a level of the aqueous hydrogen peroxide solution in the intermediate storage tank is 30% or more of an internal height of the intermediate storage tank.

23. A system for purifying an aqueous hydrogen peroxide solution, comprising:
a resin mixing tank having a gas injection pipe and resin transfer pipe connected thereto;
a purification tower provided downstream of the resin mixing tank; and
a discharge pipe connected to a rear end of the purification tower,
wherein a mixed ion-exchange resin is prepared by introducing a mixture of a cation-exchange resin, an anion-exchange resin and water into the resin mixing tank, and then injecting a gas into the mixture through the gas injection pipe, thereby bubbling the mixture,
the prepared mixed ion-exchange resin is introduced into the purification tower through the resin transfer pipe, and
the aqueous hydrogen peroxide solution is introduced into the purification tower and passed through the mixed ion-exchange resin.
